(19) United States
(12) Patent Application Publication
(10) Pub. No.: US 2026/0320608 A1
(43) Pub. Date: Oct. 15, 2026

(54) Environment Sensing and Fraud Detection with Mesh-Based Steganography and Gen AI

(71) Applicant: Bank of America Corporation, Charlotte, NC (US)

(72) Inventors: Adam King, Fort Mill, SC (US); Naga Vamsi Krishna Akkapeddi, Charlotte, NC (US); Sanjay Lohar, Mint Hill, NC (US); Prem Obhan, Frisco, TX (US); Maribeth M. Nguyen, Los Angeles, CA (US); Prakash Kumar, Charlotte, NC (US); Sambamurthy Nalla, Flower Mount, TX (US)

(21) Appl. No.: 19/177,849

(22) Filed: Apr. 14, 2025

(51) Int. Cl. G06Q 20/40; G06Q 20/38; G06Q 20/42

(52) U.S. Cl. CPC G06Q 20/40145; G06Q 20/3829; G06Q 20/42

(57) ABSTRACT

A method and system secure transactions across multiple devices by registering a user's device mesh with a cloud service, capturing hard and soft biometric data from each device, and generating a steganographic image divided into pieces assigned to the devices. The cloud associates the image with a transaction type, and a device initiates a transaction via a steganographic network. Validation requests a subset of devices to provide image pieces within a time limit, reconstructing the image for authorization. If validation fails, artificial intelligence generates a software update for a device, activating sensors to collect environmental data. The cloud analyzes this data, blocking transactions or alerting authorities if anomalies are detected. Unique features include random mesh participation, biometric-based steganography, AI-driven updates, and secure network communication, enhancing multi-device transaction security.

### TECHNICAL FIELD

The inventions disclosed herein pertain to techniques for enhancing security in electronic communications and data processing across networked devices, focusing on systems that employ cryptographic methods to conceal and protect information within digital images and networks. These techniques involve the integration of biometric authentication mechanisms with distributed device networks to ensure secure transaction validation and user authorization in real-time. Additionally, the inventions encompass adaptive software updates driven by artificial intelligence to analyze environmental data collected from device sensors, enabling dynamic responses to potential security threats. The disclosed systems and methods leverage interconnected device ecosystems and advanced computational algorithms to improve the integrity and confidentiality of transactional processes in a digital environment.

### DESCRIPTION OF THE RELATED ART

The rapid expansion of digital transactions across multiple devices has introduced significant challenges in maintaining security and authenticity. Users often initiate a transaction on one device, such as a smartphone, and later continue or complete it on another, like a laptop or tablet. This multi-device interaction, while convenient, creates vulnerabilities that malicious actors can target. Traditional systems struggle to ensure that the same user is behind each step of the transaction, especially when devices switch mid-process. The lack of continuity in verifying identity across these transitions opens the door to unauthorized access, where someone could intercept or take over a transaction without detection.

Another issue arises from the increasing variety of devices involved in transactions. With the rise of Internet of Things (IoT) devices, such as smartwatches, home assistants, and connected appliances, the ecosystem has grown more complex. Each device has unique capabilities and weaknesses, making it difficult to apply a uniform security standard. A transaction that spans a smartphone, a smartwatch, and a desktop computer, for example, may encounter inconsistent authentication methods. This fragmentation weakens the overall security framework, as a breach in one device could compromise the entire transaction chain.

Fraudulent activities have become more sophisticated in this environment. Attackers can hijack a device or spoof a user's presence, tricking systems into believing the transaction is legitimate. For instance, a user might start a financial transfer on their phone, pause it, and later resume it, only to find that an unauthorized party has completed it from a different location. Current solutions often rely on single-device authentication, such as a password or a one-time code, which does not account for the dynamic nature of multi-device use. This leaves gaps that fraudsters target, particularly when geographic or contextual clues are ignored.

Confidentiality concerns compound these security issues. Users expect their transactional data to remain private, yet the involvement of multiple devices increases the risk of exposure. Each device may communicate with a central server or cloud service, transmitting sensitive information that could be intercepted. Without strong protection, this data becomes a target for attackers. The challenge lies in safeguarding this information while still allowing seamless interaction across devices, a balance that existing approaches struggle to achieve.

Real-time action is another hurdle. Transactions often require immediate validation to proceed, but verifying a user's identity across multiple devices in a short timeframe is complex. Delays in authentication can frustrate users, while rushed processes may overlook potential threats. Systems need to detect anomalies—like a sudden shift in location or device—quickly and accurately. However, many current methods lack the speed and precision to flag suspicious activity before a transaction completes, leaving users vulnerable to loss.

The evolution of IoT devices amplifies these problems. Unlike traditional computers or phones, IoT devices often have limited processing power and security features. A smart thermostat or wearable device, for example, might participate in a transaction but lack the ability to perform advanced authentication. This disparity creates weak links in the chain, where an attacker could focus on the least secure device to gain access. As more such devices enter daily use, the potential for fraud grows, outpacing the capabilities of conventional security measures.

Environmental factors add further complexity. A user's physical surroundings—such as their location, the presence of others, or ambient conditions—can provide clues about the legitimacy of a transaction. Yet, most systems do not account for this context. An attacker operating from a different country or a crowded public space might mimic a user's digital signature, but subtle differences in surroundings could reveal the deception if properly analyzed. The absence of mechanisms to sense and interpret these factors limits the ability to distinguish genuine users from impostors.

Timing also plays a role in transaction security. Fraudsters often step in during pauses between transaction steps to alter or complete them. Current multi-factor authentication methods, while effective for single-device scenarios, do not adapt well to time-sensitive, multi-device workflows. A token sent to a phone might expire before the user switches devices, or worse, be intercepted by someone else. This lack of temporal coordination undermines trust in the system, as users cannot rely on consistent protection throughout the transaction lifecycle.

Scalability poses an additional challenge. As the number of devices per user increases, so does the difficulty of monitoring and securing each one. A single person might own a phone, tablet, laptop, smartwatch, and several IoT gadgets, all potentially involved in transactions. Tracking activity across this network without overwhelming the user or the system requires a level of sophistication that existing solutions lack. The result is a patchwork of security measures that fail to provide comprehensive coverage, leaving openings for manipulation.

The long felt and unmet need for a solution stems from the persistent rise in transaction fraud despite years of advancements in digital security. For over a decade, industries have sought ways to unify authentication across diverse devices while addressing confidentiality, speed, and environmental awareness. Traditional methods, tethered to single-device paradigms, have not kept pace with the shift to omnichannel experiences and IoT integration. This gap has fueled ongoing losses and eroded user confidence, highlighting the demand for a system that can seamlessly secure transactions across a user's device ecosystem while adapting to emerging threats in real time.

### SUMMARY OF THE INVENTION

The invention introduces a system where a user registers a collection of devices, referred to as a mesh, to enhance security in digital transactions. This mesh consists of various devices owned by the user, such as smartphones, laptops, tablets, and IoT gadgets, all linked to the user's profile through an opt-in process. Registration occurs via a cloud-based repository, which stores and manages the mesh configuration. This setup allows the system to recognize and interact with the user's devices as a unified network, providing a foundation for subsequent security measures.

Once the mesh is established, the system incorporates biometric authentication across these devices. Two types of biometrics are utilized: hard biometrics, such as a combination of thumbprints and eye scans or index finger and dual-eye scans, and soft biometrics, which include user-specific gestures performed on each device. These biometrics can be applied individually or in combination, depending on the device's capabilities and the user's preferences. The integration of biometrics into the mesh ensures that each device can independently verify the user's identity, creating a multi-layered authentication framework.

A key feature of the invention involves the creation of steganographic images using these biometric inputs. Users generate these images by combining their hard and soft biometrics, with each image designed so that distinct pieces correspond to specific devices within the mesh. For example, one device might hold a segment representing a thumbprint, while another stores a gesture-based fragment. These pieces collectively form a complete steganographic image, which is stored in the cloud repository in an encrypted format. The steganographic approach conceals the biometric data within the image, adding a layer of security through obscurity.

The invention ties these steganographic images to specific transaction types or allows their random selection for authentication purposes. When a user initiates a transaction, the system leverages the mesh to validate their identity using these images. The initiating device shares biometric data and fingerprint details—such as timestamps of biometric creation or updates—with the cloud via a steganographic network. This network employs steganographic techniques to embed and transmit data securely, ensuring that communications between the cloud and the mesh remain confidential and tamper-resistant.

Upon receiving a transaction request, the cloud service communicates with the mesh through the steganographic network, requesting either a full or partial response from the devices. In a partial request scenario, the system might ask three out of five devices to provide their respective image pieces, which must align to reconstruct the complete steganographic image. Each device prompts the user for the necessary biometric input, such as a thumb scan or gesture, to release its segment. A time-to-live token accompanies this request, setting a strict deadline—typically a minute or two—for the devices to respond, ensuring real-time validation.

If all requested devices provide their image pieces within the allotted time, the cloud reassembles the steganographic image and verifies the user's identity, authorizing the transaction to proceed. However, if the user fails to respond fully or partially—for instance, if one device is unavailable or compromised—the image cannot be completed, and the transaction is denied. This mechanism ensures that only the legitimate user, with access to the registered mesh devices, can complete the process, thwarting unauthorized attempts.

In situations where validation falters, the invention employs an adaptive response mechanism. If a user struggles to authenticate, such as missing the time window on multiple attempts, the cloud service triggers an additional evaluation step. This involves generating a software update tailored to one or more devices in the mesh, crafted using generative artificial intelligence (Gen AI). The update is deployed to the device, prompting a restart to implement changes, and targets pre-identified sensors within the device, such as those detecting motion, light, or proximity.

The software update enhances or replaces the functionality of these sensors, enabling them to collect detailed environmental data. For example, the updated sensor might detect the presence of third parties near the device, gauging factors like the number of individuals, ambient light levels, humidity, or air pressure. This data provides a snapshot of the user's surroundings during the transaction attempt, offering contextual clues about potential security risks. The device then transmits this information back to the cloud via the steganographic network for further analysis.

The cloud service uses Gen AI to process the environmental data, identifying anomalies that could indicate fraud. For instance, if a transaction originates in one geographic region but the environmental data suggests a different location—perhaps due to mismatched humidity or light conditions—the system flags the discrepancy. This analysis extends beyond simple geolocation, which can be spoofed using VPNs, by incorporating physical environmental signatures that are harder to manipulate. The AI-driven approach allows the system to adapt to diverse scenarios without predefined rules.

When the analysis detects a potential threat, the cloud service takes decisive action. It may send alerts to relevant authorities, such as financial institutions or law enforcement, to investigate further. Simultaneously, the system can block large financial transactions or halt multiple frequent transactions that might suggest fraudulent activity, such as those designed to evade detection thresholds. This proactive response leverages the mesh's distributed nature and the AI's analytical capabilities to mitigate risks in real time.

The use of a steganographic network for communication between the cloud and the mesh is a distinctive aspect of the invention. By embedding sensitive data within seemingly innocuous transmissions, the network ensures that biometric details, image pieces, and environmental data remain secure during transit. This approach contrasts with traditional encryption, offering an additional layer of protection through concealment, making it harder for attackers to intercept or decipher the information.

The invention's reliance on both full and partial mesh participation adds flexibility to the authentication process. A full mesh request requires all devices to contribute their image pieces, providing maximum security for high-value transactions. In contrast, a partial mesh request, where only a subset of devices responds, balances security with convenience for routine activities. The system dynamically selects the appropriate level of participation based on the transaction's context, optimizing user experience without compromising safety.

The incorporation of hard and soft biometrics into steganographic images enhances the system's robustness. Hard biometrics provide a reliable, physical anchor for identity verification, while soft biometrics introduce a behavioral element that is unique to the user's interaction with each device. This dual approach ensures that even if one biometric type is compromised, the other can still validate the user, reducing the likelihood of successful impersonation.

The Gen AI-driven software updates represent a forward-thinking component of the invention. By tailoring updates to specific devices and situations, the system adapts to emerging threats without requiring manual intervention. The AI's ability to analyze sensor data and generate updates on the fly allows the invention to evolve alongside fraud tactics, maintaining its effectiveness over time. This adaptability is particularly valuable in the context of IoT devices, which often lack the resources for complex onboard security measures.

The mesh serves as a multi-factor authentication platform, integrating device ownership, biometric inputs, and environmental context into a cohesive system. Each factor—possession of the registered devices, knowledge of the gestures, and presence in a consistent environment—must align for authentication to succeed. This multi-faceted approach surpasses traditional two-factor methods, offering a higher degree of assurance in user verification across diverse transaction scenarios.

The invention's use of pre-identified sensors to gather environmental data adds a novel dimension to transaction security. Rather than relying solely on digital signatures or network-based checks, the system incorporates physical world inputs to validate the user's context. This capability is especially effective in detecting sophisticated attacks, such as those involving remote device hijacking or man-in-the-middle interference, where digital signals might be forged but environmental conditions cannot.

The cloud-based Gen AI analysis ties the invention's components together, providing a centralized hub for decision-making. By processing biometric, steganographic, and environmental data, the AI delivers a comprehensive assessment of each transaction's legitimacy. Its ability to act adaptively—issuing alerts, blocking transactions, or adjusting authentication requirements—ensures that the system responds to threats in a manner proportional to the risk detected.

The invention's design accommodates a wide range of devices, from traditional computers to resource-constrained IoT gadgets. By distributing authentication tasks across the mesh and leveraging cloud resources, the system minimizes the burden on individual devices while maximizing security. This scalability makes it suitable for users with extensive device ecosystems, ensuring consistent protection as the number of connected devices grows.

The combination of steganography, biometrics, AI, and sensor data creates a unique security framework. Each element reinforces the others, forming a system where breaches in one area—such as a stolen device—do not automatically compromise the whole. This interconnectedness, paired with real-time adaptability, positions the invention as a comprehensive solution for securing transactions in a multi-device world.

In light of the preceding discussion, the following identifies various sample embodiments of the present disclosure to establish a basic understanding of its various components. This summary is not exhaustive, nor does it limit the illustrative embodiments of the inventions described in this document. It is not intended to identify the most essential features or steps of the disclosure, nor to define its scope. Instead, as would be recognized by someone skilled in the field, it seeks to introduce certain concepts of the disclosure in a clear and simple way, acting as a preface to the more detailed explanation that follows. Throughout this application, the specification offers thorough written descriptions of the inventions, including exemplary, non-exhaustive, and non-limiting methods and processes for making and using the inventions. These descriptions are expressed in complete, clear, concise, and precise terms, allowing those skilled in the art to implement and utilize various embodiments of the inventions without undue experimentation.

In some arrangements, a method secures transactions across multiple devices by utilizing a cloud service to register a mesh of devices associated with a user. This mesh includes a plurality of devices, each configured to communicate with the cloud service. Each device in the mesh captures biometric data, which includes a hard biometric and a soft biometric specific to the user. The mesh generates a steganographic image using this biometric data, dividing the image into pieces, with each piece assigned to a respective device in the mesh.

In some arrangements, the cloud service associates the steganographic image with a specific transaction type. A first device in the mesh initiates a transaction of this transaction type by sending initial biometric data to the cloud service through a steganographic network. The cloud service validates the transaction by requesting a subset of the devices in the mesh to provide their respective pieces of the steganographic image within a specified time limit, where each device in the subset provides its piece after verifying current biometric data against the captured biometric data. The cloud service reconstructs the steganographic image from the provided pieces and authorizes the transaction if the reconstructed steganographic image matches the associated steganographic image.

In some arrangements, the subset of the devices requested by the cloud service to provide their pieces of the steganographic image includes at least two devices but fewer than all devices in the mesh. This limitation ensures that the validation process involves multiple devices without requiring participation from the entire mesh, balancing security and efficiency.

In some arrangements, the cloud service selects the subset of the devices randomly from the mesh to provide their pieces of the steganographic image. The cloud service also adjusts the size of this subset based on the value of the transaction, allowing for greater scrutiny for higher-value transactions while maintaining flexibility for lower-value ones.

In some arrangements, the hard biometric captured by each device in the mesh includes a combination of a thumb scan and an eye scan. This specific combination ensures a robust and reliable biometric foundation for generating the steganographic image and verifying the user's identity across the mesh.

In some arrangements, an artificial intelligence in the cloud service generates a software update for a second device in the mesh if the transaction is not authorized. The cloud service deploys this software update to the second device. Upon receiving the update, the second device restarts to implement the software update, enabling further evaluation of the transaction environment.

In some arrangements, the software update deployed to the second device activates a sensor in that device to collect environmental data, which includes light levels and proximity information. This activation allows the system to gather contextual data that may indicate potential security concerns surrounding the transaction attempt.

In some arrangements, the second device sends the environmental data, including light levels and proximity information, to the cloud service via the steganographic network. The artificial intelligence in the cloud service analyzes this environmental data to detect the presence of a third party near the second device, providing an additional layer of security assessment.

In some arrangements, the cloud service blocks the transaction if the artificial intelligence detects the presence of a third party near the second device based on the environmental data analysis. This blocking mechanism prevents potentially compromised transactions from proceeding, enhancing overall security.

In some arrangements, the cloud service sends an alert to an authority if the transaction is blocked due to the detection of a third party. The cloud service also logs the transaction attempt, recording a timestamp and the environmental data for future reference and analysis. Additionally, the cloud service adjusts the time limit for providing the pieces of the steganographic image based on a historical pattern of transaction attempts by the user, tailoring the process to individual usage trends.

In some arrangements, a comprehensive method secures transactions across multiple devices through a series of integrated steps managed by a cloud service. The cloud service registers a mesh of devices associated with a user, where the mesh includes a plurality of devices, each configured to communicate with the cloud service. Each device in the mesh captures biometric data, including a hard biometric and a soft biometric specific to the user. The mesh generates a steganographic image using this biometric data, dividing it into pieces, with each piece assigned to a respective device in the mesh.

In some arrangements, the cloud service associates this steganographic image with a transaction type. A first device in the mesh initiates a transaction of this type by sending initial biometric data to the cloud service via a steganographic network. The cloud service validates the transaction by requesting a subset of the devices in the mesh to provide their respective pieces of the steganographic image within a time limit, where the subset includes at least two devices but fewer than all devices in the mesh, and each device provides its piece upon verifying current biometric data against the captured biometric data.

In some arrangements, the cloud service selects the subset of devices randomly from the mesh and adjusts the size of the subset based on the transaction's value. The cloud service reconstructs the steganographic image from the provided pieces and authorizes the transaction if the reconstructed image matches the associated steganographic image. If the transaction is not authorized, an artificial intelligence in the cloud service generates a software update for a second device in the mesh, which the cloud service deploys, prompting the second device to restart and implement the update.

In some arrangements, this software update activates a sensor in the second device to collect environmental data, including light levels and proximity information. The second device sends this environmental data to the cloud service via the steganographic network. The artificial intelligence analyzes the environmental data to detect a third party near the second device, and the cloud service blocks the transaction if such a presence is detected, subsequently sending an alert to an authority and logging the attempt with a timestamp and environmental data.

In some arrangements, the cloud service encrypts the steganographic image prior to storage and distributes a decryption key to the mesh for reconstructing the image during validation. The cloud service also adjusts the time limit for providing the image pieces based on historical transaction patterns by the user, ensuring adaptability. These additional steps enhance the security and integrity of the transaction process across the mesh.

In some arrangements, a system secures transactions across multiple devices using a cloud service configured to register a mesh of devices associated with a user. This mesh includes a plurality of devices, each configured to communicate with the cloud service. The plurality of devices in the mesh each capture biometric data, including a hard biometric and a soft biometric specific to the user. The mesh generates a steganographic image using this biometric data, dividing it into pieces, with each piece assigned to a respective device in the mesh.

In some arrangements, the cloud service associates the steganographic image with a transaction type. A first device in the mesh initiates a transaction of this type by sending initial biometric data to the cloud service via a steganographic network. The cloud service validates the transaction by requesting a subset of the devices in the mesh to provide their respective pieces of the steganographic image within a time limit, with each device in the subset configured to provide its piece upon verifying current biometric data against the captured biometric data. The cloud service reconstructs the steganographic image from the provided pieces and authorizes the transaction if the reconstructed image matches the associated steganographic image.

In some arrangements, the cloud service is configured to select the subset of the devices randomly from the mesh to provide their pieces of the steganographic image. This random selection ensures unpredictability in the validation process, enhancing security across the system.

In some arrangements, the plurality of devices in the mesh includes at least one mobile device and at least one Internet of Things device. This diversity in device types accommodates a wide range of user hardware while maintaining the integrity of the steganographic image generation and transaction validation processes.

In some arrangements, an artificial intelligence in the cloud service generates a software update for a second device in the mesh if the transaction is not authorized. The cloud service deploys this update, and the second device restarts upon receiving the software update to implement it, enabling further security measures to be enacted.

In some arrangements, the second device is configured to collect environmental data using a sensor activated by the software update. This collection of environmental data provides contextual information that the system uses to assess the security of the transaction environment.

In some arrangements, the cloud service analyzes the environmental data collected by the second device to assess a security condition of that device. This analysis determines whether the transaction environment poses a risk, allowing the system to respond accordingly.

In some arrangements, the cloud service blocks the transaction based on the security condition determined from the environmental data analysis. The cloud service also sends a notification to the user if the transaction is blocked, keeping the user informed of security actions taken by the system.

In some arrangements, the cloud service adjusts the size of the subset of devices requested to provide their pieces of the steganographic image based on a predefined criterion associated with the transaction. This adjustment ensures that the validation process aligns with the specific needs and risks of each transaction.

In some arrangements, the cloud service encrypts all communications within the steganographic network using a unique key generated for each transaction. An artificial intelligence in the cloud service predicts a potential security threat based on a pattern of environmental data collected from the second device over multiple transactions. If a threat is predicted, the cloud service requests additional biometric data from a third device in the mesh.

In some arrangements, the third device provides this additional biometric data to update its respective piece of the steganographic image. The cloud service revalidates the transaction using the updated piece from the third device in combination with the pieces from the subset, with this revalidation occurring within an extended time limit determined by the artificial intelligence based on the predicted security threat. These steps ensure a thorough and adaptive security process tailored to emerging risks.

The following description and claims, in conjunction with the drawings—all integral parts of this specification—will clarify various features and characteristics of the current technology. Like reference numerals in the figures correspond to similar parts, enhancing understanding of the technology's methods of operation and the functions of related structural elements, as well as the synergies and economies of their combinations. Some of the processes or procedures described here may be implemented, in whole or in part, as computer-executable instructions recorded on non-transitory computer-readable media, configured as computer modules, or in other computer constructs. These steps and functionalities may be executed on a single device or distributed across multiple devices interconnected with one another. However, it is important to acknowledge that the drawings primarily serve for descriptive and illustrative purposes and are not intended to delineate the limits of the invention. Unless contextually evident, the singular forms of “a,” “an,” and “the” used throughout the specification and claims should be interpreted to include their plural counterparts.

### BRIEF DESCRIPTION OF DRAWINGS

FIG. 1 is an exemplary system architecture diagram in accordance with one or more embodiments disclosed herein that illustrates the interconnected components facilitating secure transaction processing across multiple devices. It depicts the intricate relationships and data flows between the cloud service, device mesh, mobile and IoT devices, steganographic network, artificial intelligence, sensors, and transaction processor within a distributed security framework.

FIG. 2 is an exemplary flow diagram in accordance with one or more embodiments disclosed herein that illustrates the sequential process for securing transactions across multiple devices using a mesh-based steganographic and AI-driven approach. It outlines the steps from device registration to transaction authorization, including adaptive security measures triggered by environmental analysis.

FIG. 3 is an exemplary sequence diagram in accordance with one or more embodiments disclosed herein that illustrates the interactions between key actors in securing a transaction across multiple devices. It details the step-by-step communication flow among the cloud service, mesh devices, steganographic network, artificial intelligence, and transaction processor to achieve robust authentication and adaptive security.

FIG. 4 is an exemplary class diagram in accordance with one or more embodiments disclosed herein that illustrates the object-oriented structure and relationships among the core classes enabling secure transaction processing across multiple devices. It delineates the attributes, methods, and interconnections of the system's components, facilitating a comprehensive implementation of the invention's security framework.

### DETAILED DESCRIPTION

The invention presents a sophisticated approach to securing transactions across multiple devices by leveraging a networked collection of user-owned devices, referred to as a mesh, which collectively participate in an authentication process managed by a cloud service. This mesh comprises various devices such as smartphones, tablets, laptops, and Internet of Things gadgets, each registered under a user's profile through a cloud-based system that maintains their connectivity and operational status. The cloud service orchestrates the interactions among these devices, ensuring that they function as a cohesive unit to validate transactions, thereby addressing the complexities of multi-device usage in modern digital environments.

Each device within the mesh captures biometric data unique to the user, encompassing both hard biometrics, such as thumb scans combined with eye scans, and soft biometrics, like specific gestures performed on touchscreens or other interfaces. This dual biometric approach enhances the reliability of user identification, as it combines physical traits with behavioral patterns, making it more difficult for unauthorized parties to replicate the full set of credentials. The biometric data collected from these devices serves as the foundation for generating a steganographic image, a key element in the invention's security framework, which is crafted to conceal sensitive information within a seemingly ordinary digital file.

The creation of the steganographic image involves combining the biometric data from all devices in the mesh into a single image, which is then segmented into distinct pieces, with each piece assigned to a specific device. This division ensures that no single device holds the complete image, distributing the authentication responsibility across the mesh and reducing the risk of a single point of failure or compromise. The cloud service stores the original steganographic image and associates it with particular transaction types, such as payments or data transfers, allowing the system to reference it during validation processes tailored to specific activities.

When a user initiates a transaction, typically through one device in the mesh, that device sends initial biometric data to the cloud service via a steganographic network, a specialized communication channel that embeds data within carriers like images or audio files to maintain confidentiality. The cloud service responds by requesting a subset of devices in the mesh to provide their respective pieces of the steganographic image, imposing a time limit—often two minutes—to ensure prompt responses and prevent delays that could indicate interference. Each device in the subset verifies the user's current biometric input against its stored data, releasing its image piece only upon a match, which adds an additional layer of real-time authentication to the process.

The cloud service reconstructs the steganographic image from the pieces provided by the subset of devices, comparing the result to the stored original to determine if they align, a step that confirms the user's identity and authorizes the transaction if successful. This reconstruction process relies on precise alignment of the image segments, ensuring that the biometric data encoded within them remains intact and verifiable, a feature that leverages the distributed nature of the mesh to enhance security. If the images match, the transaction proceeds, potentially integrating with external systems like payment gateways to complete financial exchanges or data operations, seamlessly bridging the invention's internal security with practical outcomes.

In cases where the transaction fails authorization—due to mismatched images, timeouts, or incomplete responses—the invention introduces an adaptive mechanism driven by artificial intelligence within the cloud service. The artificial intelligence generates a software update tailored to a specific device in the mesh, designed to enhance its capabilities by activating or upgrading its sensors, a response triggered when initial validation attempts suggest potential security concerns. This update is deployed to the device, prompting a restart to implement the changes, which enables the device to collect detailed environmental data such as light levels, proximity information, or ambient conditions, offering a broader context for assessing the transaction's legitimacy.

The updated device gathers this environmental data using its activated sensors and transmits it back to the cloud service through the steganographic network, maintaining the same concealment techniques to protect the information during transfer. The artificial intelligence then analyzes this data, evaluating factors like unusual proximity or lighting changes that might indicate the presence of a third party near the device, a capability that adds a physical-world dimension to the digital security framework. If the analysis detects anomalies suggestive of interference, the cloud service blocks the transaction, preventing potential unauthorized access and preserving the integrity of the user's assets or information.

Upon blocking a transaction, the cloud service sends an alert to an appropriate authority, such as a financial institution or security team, providing details of the attempt and the environmental data that triggered the action, ensuring rapid response to potential threats. The system also logs the transaction attempt, recording timestamps, device responses, and environmental readings in a secure database, creating a comprehensive audit trail that can be reviewed to refine security measures or investigate incidents. This logging process supports long-term adaptability, as the cloud service can adjust operational parameters—like the time limit for image piece submission—based on historical patterns of user transaction attempts, tailoring the system to individual behaviors over time.

The invention's use of a steganographic network for all communications between the cloud service and mesh devices distinguishes it from conventional encryption methods, as it embeds sensitive data within innocuous carriers, adding an extra layer of obscurity that complicates interception efforts. This network facilitates the secure exchange of biometric data, image pieces, and environmental information, ensuring that each transmission remains hidden from potential attackers who might monitor standard channels. The steganographic approach aligns with the distributed nature of the mesh, as it supports the segmented handling of data across multiple devices without requiring a centralized, vulnerable repository.

The flexibility of the mesh validation process allows the cloud service to request either a full set of devices or a partial subset to contribute image pieces, a decision that can be randomized or adjusted based on transaction value or risk level, optimizing both security and user convenience. This partial participation capability ensures that the system remains operational even if some devices are unavailable, a practical consideration for users with extensive device ecosystems who might not always have all devices on hand. The ability to dynamically select devices enhances the invention's resilience, as it prevents predictability that could be exploited by adversaries attempting to mimic the authentication process.

The integration of hard and soft biometrics into the steganographic image creation process provides a robust dual-authentication mechanism, where physical identifiers like thumb scans complement behavioral traits like gestures, increasing the difficulty of forging a complete user profile. Each device's contribution to the image reflects its unique biometric capture, ensuring that the resulting pieces are interdependent yet individually verifiable, a design that leverages the diversity of device capabilities within the mesh. This dual approach, combined with the steganographic concealment, creates a multi-faceted barrier against unauthorized access, requiring attackers to overcome both biometric and data-hiding challenges simultaneously.

The artificial intelligence's role extends beyond generating software updates, as it also analyzes environmental data to detect subtle anomalies that might escape traditional security checks, such as a sudden change in device surroundings that suggests tampering or coercion. By activating sensors through targeted updates, the system gains real-time insight into the physical context of a transaction, a feature that traditional digital-only authentication methods lack, bridging the gap between virtual and physical security domains. This environmental awareness, processed through advanced analytical models, allows the invention to respond proactively to emerging threats, adapting its defenses without requiring manual intervention.

The Transaction Processor class within the system handles the reconstruction and comparison of steganographic images, as well as the final authorization or blocking of transactions, acting as a dedicated component that interfaces with external systems to execute outcomes. This separation of duties ensures that transaction-specific logic remains modular, allowing the cloud service to focus on coordination while the processor manages operational details, a design that supports scalability across thousands of users and transactions. The processor's ability to block transactions based on artificial intelligence findings or log attempts for audit purposes integrates seamlessly with the broader security framework, ensuring that each step reinforces the others.

The invention's unique aspects—such as the use of steganographic images tied to transactions, random or partial mesh participation, and AI-driven environmental sensing—combine to form a comprehensive security solution that addresses the challenges of multi-device transaction environments. The distributed nature of the mesh, paired with the steganographic network's concealment and the artificial intelligence's adaptability, creates a system that not only verifies user identity but also monitors the context of each transaction, offering a holistic approach to security. This integration of technologies ensures that the invention can evolve with changing device landscapes and threat vectors, maintaining its effectiveness over time.

The connections among the system's components, such as the Cloud Service's associations with the Mesh, Steganographic Network, Artificial Intelligence, and Transaction Processor, reflect a tightly knit architecture where each class contributes to the overall goal of secure transaction processing. These relationships, implemented through object-oriented principles like association and dependency, allow the system to function as a unified whole, with data flowing securely from devices to the cloud and back, processed by intelligent algorithms that enhance decision-making. The invention's design accommodates a wide range of devices and use cases, from mobile phones to IoT gadgets, making it a versatile solution for modern digital interactions.

Various example embodiments in the disclosure are designed to fulfill the objectives mentioned in the preceding overview, providing detailed illustrations through figures like system architecture diagrams, flow diagrams, sequence diagrams, and class diagrams that showcase the systems and methods for implementing the invention's secure transaction framework. These illustrations, integral to the disclosure, demonstrate how the components interact to achieve robust authentication and adaptive security, though different implementation approaches remain possible, allowing adjustments to the structure and operation of the system as needed, with connections among components understood flexibly as direct or indirect, wired or wireless, unless specified otherwise, ensuring adaptability to diverse technological environments.

One type of artificial intelligence applicable to the invention is supervised learning, which involves training models on labeled datasets to make predictions or classifications based on input data, a method well-suited to analyzing environmental data collected from device sensors. In this context, supervised learning could be used to detect third-party presence by training a model on examples of proximity and light level readings labeled as “normal” or “anomalous,” enabling the Artificial Intelligence (408) class to classify real-time data during transaction attempts, with tools like scikit-learn's Random Forest Classifier or TensorFlow's Keras API facilitating implementation on cloud platforms like AWS SageMaker, where the model learns to distinguish legitimate user contexts from potential threats.

Another applicable type is generative adversarial networks, a form of artificial intelligence where two neural networks—a generator and a discriminator—compete to produce and evaluate synthetic data, offering a powerful approach to creating software updates for devices in the mesh. The Artificial Intelligence (408) class could employ GANs to generate firmware patches tailored to specific devices based on sensor data inputs, with the generator crafting updates to enhance sensor functionality and the discriminator ensuring their effectiveness, implemented using PyTorch on Google Cloud TPUs, where synthetic sensor data trains the model to adapt device behavior dynamically, enhancing the system's responsiveness to security challenges.

Reinforcement learning, where an agent learns to make decisions by receiving rewards or consequences based on actions in an environment, also applies to optimizing the transaction validation process within the invention. This type could adjust the subset size of devices requested for steganographic image pieces, with the Cloud Service (400) class using a reinforcement learning agent to maximize transaction success rates while minimizing user effort, implemented with OpenAI's Gym toolkit and a Q-learning algorithm on an EC2 instance, where the agent learns from historical transaction outcomes to balance security and convenience over time, refining the system's operational efficiency.

Unsupervised learning, which identifies patterns in unlabeled data without predefined outcomes, could enhance the invention by clustering transaction attempt patterns to inform time limit adjustments or anomaly detection. The Cloud Service (400) class might use this to group user behaviors—such as typical response times or device usage—analyzing logs with tools like Python's K-Means clustering in scikit-learn, run on a Databricks cluster, allowing the system to adapt its parameters to individual user habits without requiring labeled fraud data, improving its flexibility and proactive threat identification across diverse user scenarios.

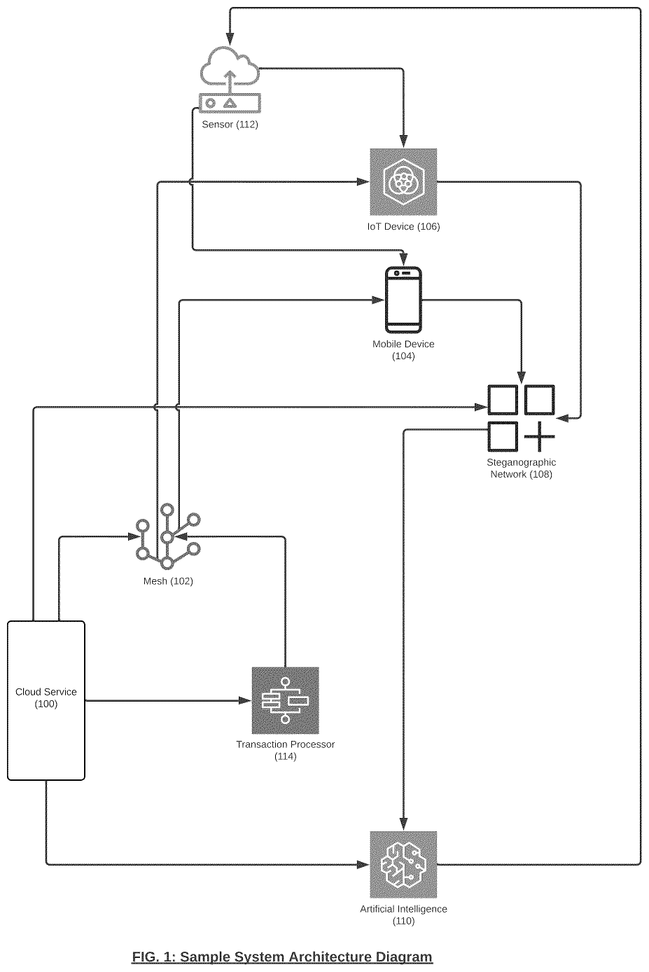

The FIG. 1 system architecture diagram centers on the Cloud Service (100), which functions as the foundational hub orchestrating all aspects of the invention's operations, data management, and device coordination. This component could be implemented on a robust, scalable platform such as Amazon Web Services, Google Cloud Platform, or Microsoft Azure, leveraging their extensive infrastructure of virtual machines, storage solutions like Amazon S3 buckets, and relational databases such as PostgreSQL or MySQL to store user profiles, device registrations, and encrypted steganographic images. The Cloud Service (100) might utilize containerization technologies like Docker or Kubernetes to manage microservices that handle tasks such as user authentication, transaction logging, and communication routing, ensuring high availability and fault tolerance across geographically distributed data centers.

The Cloud Service (100) establishes a direct connection to the Mesh (102), which represents a cohesive network of devices associated with a single user, designed to operate collaboratively for authentication and transaction validation. An example of the Mesh (102) could include a user's personal ecosystem comprising an iPhone 14, an iPad Pro, a Dell XPS laptop, a Samsung Galaxy Watch, and a Nest Hub smart display, all registered under the user's unique identifier in the Cloud Service (100). Each device in the Mesh (102) could be equipped with distinct hardware capabilities, such as touchscreens, cameras, or microphones, allowing it to contribute to the system's distributed security processes. The Mesh (102) might rely on a lightweight client application, developed in languages like Swift for iOS devices or Kotlin for Android, to facilitate communication with the Cloud Service (100) and manage local data storage in secure enclaves like the iPhone's Secure Enclave or Android's Keystore.

From the Mesh (102), connections extend to two specific device types: the Mobile Device (104) and the IoT Device (106), which exemplify the diversity within the mesh. The Mobile Device (104) could be instantiated as a Google Pixel 8 smartphone or a OnePlus 12, featuring advanced biometric sensors such as an under-display fingerprint scanner, a high-resolution front-facing camera for facial recognition, or even an infrared sensor for enhanced eye scanning. These devices might run a custom security app built with React Native, enabling cross-platform compatibility, and integrate with hardware APIs like Android's BiometricPrompt or iOS's LocalAuthentication framework to capture and process biometric inputs. The Mobile Device (104) connects to the Steganographic Network (108), ensuring that all data it sends or receives remains concealed within innocuous carriers like image files or audio streams.

The IoT Device (106), branching from the Mesh (102), could be represented by a variety of connected gadgets, such as an Amazon Echo Dot, a Philips Hue smart bulb, or a Fitbit Versa 4 fitness tracker. These devices might possess more limited computational resources compared to the Mobile Device (104), yet still contribute to the system with sensors like motion detectors, ambient light sensors, or temp-independent environmental monitors. For instance, an Echo Dot could use its microphone array to capture voice-based soft biometrics, while a Fitbit might employ its photoplethysmography sensor to verify user presence through various patterns, both feeding into the Mesh (102) operations. The IoT Device (106) also links to the Steganographic Network (108), utilizing lightweight firmware written in C or Python scripts running on platforms like Raspberry Pi to handle data transmission securely.

The Steganographic Network (108) serves as the critical communication infrastructure, connecting the Cloud Service (100), Mobile Device (104), and IoT Device (106), as well as facilitating interactions between the Artificial Intelligence (110) and other components. This network could be implemented using a custom-built protocol stack that embeds sensitive data—such as biometric inputs, steganographic image pieces, or environmental readings—within digital carriers like JPEG images, MP4 video frames, or WAV audio files, leveraging open-source tools like Steghide or proprietary libraries tailored for real-time performance. The Steganographic Network (108) might operate over standard internet protocols such as HTTPS or WebSockets, with an additional layer of obfuscation achieved through algorithms that distribute data across multiple packets, requiring reassembly only by authorized endpoints like the Cloud Service (100). Redundant pathways, such as secondary connections through VPN tunnels or peer-to-peer relays, could ensure reliability even under network congestion or partial outages.

The Cloud Service (100) maintains a direct link to the Steganographic Network (108), enabling it to send commands, receive data, and coordinate the flow of transaction-related information across the system. This connection might utilize a message queue system like Apache Kafka or RabbitMQ to handle high-throughput data exchanges, ensuring that biometric verifications, image piece requests, and transaction statuses are processed in near real-time. The Steganographic Network (108) could also integrate with a content delivery network like Cloudflare to optimize latency, caching non-sensitive metadata while keeping the concealed payloads secure, thus supporting the system's scalability across thousands of users and devices.

The Artificial Intelligence (110) connects to both the Cloud Service (100) and the Steganographic Network (108), providing advanced analytical and adaptive capabilities to the architecture. This component could be realized through a machine learning framework like TensorFlow or PyTorch, deployed on GPU-accelerated instances within the Cloud Service (100), such as AWS EC2 P4d instances or Google Cloud's TPU nodes. The Artificial Intelligence (110) might consist of multiple models: one trained on synthetic datasets to generate device-specific software updates, another using convolutional neural networks to analyze environmental data patterns, and a third employing reinforcement learning to adjust validation thresholds dynamically. Training data could be sourced from anonymized transaction logs and sensor readings, stored in a data lake like AWS Lake Formation, with models updated periodically via automated pipelines using tools like Kubeflow.

The Artificial Intelligence (110) interfaces with the Sensor (112), which resides within the devices of the Mesh (102), specifically the Mobile Device (104) and IoT Device (106). The Sensor (112) represents a collection of hardware elements embedded in these devices, capable of collecting diverse environmental data. On a Mobile Device (104) like an iPhone 15, this might include a LiDAR scanner for depth perception, an ambient light sensor for brightness levels, a gyroscope for orientation, and a barometer for air pressure, all accessible via Apple's Core Motion framework. On an IoT Device (106) like a Nest Cam, the Sensor (112) could encompass a passive infrared sensor for motion detection, a microphone for ambient sound analysis, and a humidity sensor, interfaced through Google's IoT Core SDK. These sensors might operate in a low-power state until activated by a software update from the Artificial Intelligence (110), conserving battery life while remaining responsive.

The Sensor (112) establishes connections back to the Mobile Device (104) and IoT Device (106), feeding collected data into the device's local processing units before transmission through the Steganographic Network (108). For instance, a Samsung Galaxy Watch as the IoT Device (106) might use its accelerometer to detect unusual movement patterns, processed by an onboard Wear OS app, while a Mobile Device (104) like a Huawei P60 Pro could combine camera imagery with proximity sensor data to assess the user's surroundings. The Sensor (112) data could be formatted as JSON objects or binary streams, encrypted locally using AES-256 before being embedded into steganographic carriers, ensuring end-to-end security as it travels to the Cloud Service (100).

The Cloud Service (100) also connects to the Transaction Processor (114), a dedicated component responsible for managing the lifecycle of transactions within the system. This could be implemented as a standalone microservice written in Java with Spring Boot or Node.js with Express, running on the Cloud Service (100) infrastructure alongside other services. The Transaction Processor (114) might use a state machine implemented with libraries like XState to track transaction states—initiation, validation, authorization, or denial—interfacing with a NoSQL database like MongoDB to store transaction records with timestamps, device identifiers, and outcomes. It could integrate with external financial APIs, such as Stripe or PayPal, to execute authorized transactions, using RESTful endpoints secured by OAuth 2.0 tokens.

The Transaction Processor (114) links back to the Mesh (102), enabling it to request steganographic image pieces or biometric verifications from the devices during a transaction. This connection might employ a publish-subscribe model via Redis Pub/Sub, where the Transaction Processor (114) publishes validation requests, and devices in the Mesh (102) subscribe to respond with their data. For example, during a payment transaction, the Transaction Processor (114) could instruct a Mobile Device (104) like an Xperia 1 V to prompt the user for a thumb scan, while an IoT Device (106) like a Ring Doorbell provides a proximity-based image piece, coordinating these actions through the Cloud Service (100).

This expansive architecture integrates the Cloud Service (100) as the central coordinator, leveraging its computational power and storage to manage the Mesh (102) and its constituent Mobile Device (104) and IoT Device (106). The Steganographic Network (108) ensures secure, concealed communication across all components, while the Artificial Intelligence (110) and Sensor (112) add dynamic environmental awareness and adaptability. The Transaction Processor (114) ties the system together by handling transaction workflows, making this a comprehensive framework for securing multi-device interactions with real-world applicability across diverse hardware and use cases.

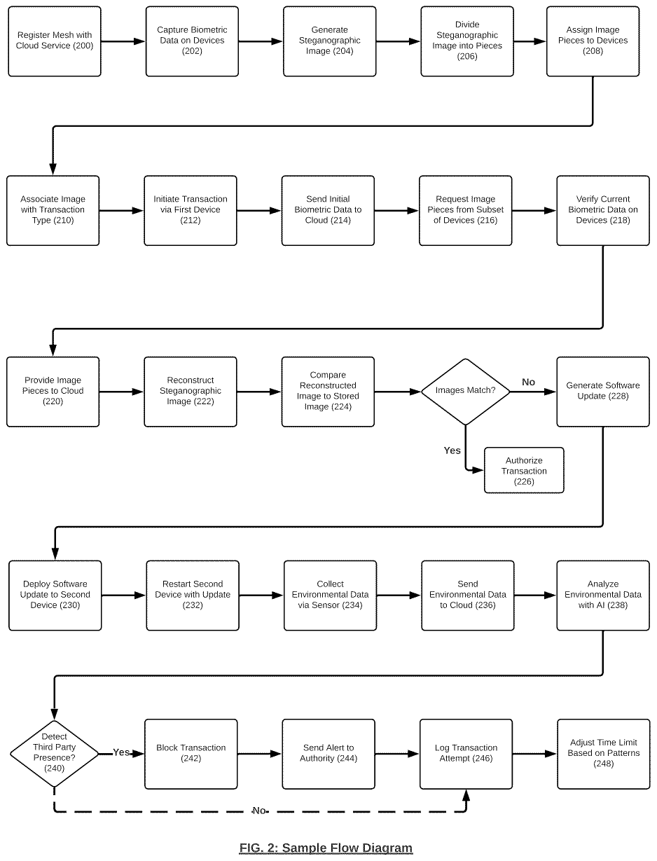

The FIG. 2 flow diagram commences with the process where a cloud service registers a mesh of devices associated with a user, establishing a network of interconnected devices under a single user profile (200). This step could be implemented using a web-based interface on a platform like Amazon Web Services, where the user logs into a portal via a secure HTTPS connection, authenticating with a username and password combination stored in an encrypted DynamoDB table. The cloud service assigns a unique identifier to the mesh, linking devices such as an iPhone 14, a Lenovo ThinkPad, and a Google Nest Hub through a RESTful API call that updates a relational database like PostgreSQL with device metadata, including MAC addresses and IP configurations. A lightweight client app, perhaps written in Python using the Flask framework, could run on each device to confirm registration by exchanging a JSON Web Token with the cloud, ensuring secure onboarding.

Next, each device within the mesh captures biometric data, specifically a hard biometric such as a thumb scan paired with an eye scan, and a soft biometric like a specific swipe gesture, all unique to the user (202). On a mobile device like a Samsung Galaxy S23, this might involve the BiometricPrompt API in Android, prompting the user to place their thumb on an under-display sensor while the front camera, leveraging Samsung's Knox security, scans their iris with infrared assistance. An IoT device like a Fitbit Charge 5 could use its touchscreen to record a custom gesture, processed by a firmware script in C that stores the data in a local secure memory partition. The captured data might be formatted as a binary string, hashed with SHA-256 for integrity, and temporarily held in a device-specific buffer before transmission.

The mesh then generates a steganographic image using the collected biometric data from all devices, creating a single digital artifact that encapsulates the user's identity (204). This step could employ a Python library like Stegano, running on a cloud-hosted virtual machine, to combine biometric hashes into a high-resolution PNG image. For example, the thumb scan data from an iPad Pro might contribute pixel values in the red channel, while eye scan data from a Huawei Mate 60 adjusts the blue channel, and gesture data from a Nest Cam modulates the green channel, resulting in a visually innocuous image like a landscape photo that secretly encodes the biometric information.

Following generation, the steganographic image is divided into distinct pieces, with the number of pieces corresponding to the number of devices in the mesh (206). A cloud-based script, possibly in Node.js, could execute this division by splitting the image into equal segments—say, four 512×512 pixel quadrants for a 1024×1024 image if four devices are registered—using the ImageMagick library to ensure precise cuts. Each piece retains a portion of the encoded biometric data, such as a quarter of the thumb scan hash in one segment, maintaining the integrity of the original image's hidden content when reassembled.

Each piece of the steganographic image is then assigned to a respective device in the mesh, distributing the security responsibility across the network (208). The cloud service might use a secure WebSocket connection to transmit each piece, encrypted with AES-256, to devices like a Dell XPS 13 laptop or an Amazon Echo Show. On receipt, a device-side application—perhaps built with Java for laptops or embedded C for IoT devices—stores the piece in a protected filesystem directory, such as /secure/stego on Linux-based systems, with access restricted by SELinux policies or iOS's sandboxing, ensuring only authorized processes can retrieve it.

The cloud service associates the complete steganographic image with a specific transaction type, such as a payment or data transfer, linking it to a user-defined category (210). This could be implemented through a cloud-hosted dashboard built with React, where the user selects “payment” from a dropdown menu, triggering a GraphQL mutation that updates a MongoDB collection with the image's hash and transaction metadata. The association might be stored as a key-value pair, with the image's SHA-512 hash as the key and the type “payment” as the value, retrievable via an API endpoint secured by OAuth 2.0.

A first device in the mesh initiates a transaction of the associated type by prompting the user to provide initial biometric input (212). For instance, an iPhone 15 could display a notification via SwiftUI, requesting a thumb scan through the Touch ID sensor, captured in real-time using Apple's LocalAuthentication framework. The device might package this input as a JSON object—{“thumb”: “base64_encoded_data”}—and prepare it for secure transmission, logging the initiation timestamp in a local SQLite database for auditing purposes.

The first device sends this initial biometric data to the cloud service through a steganographic network, embedding it within a carrier file (214). This might involve a custom Android app on a OnePlus 12 using OpenStego to hide the JSON object within a JPEG of a flower, transmitted over a TLS 1.3 connection to a cloud endpoint running Nginx as a reverse proxy. The steganographic network could employ a redundancy mechanism, splitting the carrier across multiple packets and routing them through different cloud edge nodes like those in Cloudflare's network, ensuring delivery even if some paths fail.

The cloud service requests pieces of the steganographic image from a subset of devices in the mesh, specifying a time limit for response (216). This step could use an AWS Lambda function to randomly select three out of five registered devices—say, a Galaxy Watch, an iPad, and an Echo Dot—via a Fisher-Yates shuffle algorithm, sending a JSON payload {“request”: “image_piece”, “ttl”: 120} over the steganographic network. The time limit, set to two minutes, might be enforced by a server-side timer in Redis, rejecting late responses to maintain transaction integrity.

Each device in the subset verifies current biometric data provided by the user against the originally captured biometric data stored locally (218). On a Galaxy Watch, this could involve a Wear OS app prompting a swipe gesture, compared using a cosine similarity metric against the stored gesture hash, computed with a lightweight TensorFlow Lite model running on the device's ARM processor. An iPad might verify a thumb scan with Core Image filters to enhance the input before matching, ensuring accuracy despite lighting variations, with results logged in a secure keychain.

The devices in the subset provide their respective pieces of the steganographic image to the cloud service upon successful biometric verification (220). The Echo Dot might retrieve its piece from flash memory using a Python script, encrypt it with a device-specific RSA key, and embed it in an audio WAV file sent via the steganographic network. The cloud service could receive these pieces at an API Gateway endpoint, decrypting them with corresponding public keys stored in AWS Key Management Service, assembling them in a temporary S3 bucket.

The cloud service reconstructs the steganographic image from the collected pieces, piecing together the distributed segments (222). This might involve a Go-based microservice using the imaging library to stitch the quadrants—each 512×512 pixels—back a 1024×1024 image, verifying pixel alignment with a checksum calculated during division. The reconstructed image could be held in memory on an EC2 instance, avoiding disk writes to reduce latency, with the process timed to ensure completion within milliseconds.

The cloud service compares the reconstructed steganographic image to the stored image associated with the transaction type to check for a match (224). A Python script might use the SSIM (Structural Similarity Index) algorithm from the scikit-image library to assess similarity, requiring a 95% match threshold to account for minor transmission artifacts. The comparison could run in parallel on multiple CPU cores via multiprocessing, with results stored in a Redis cache for quick retrieval if the transaction is reattempted.

If the images match, the cloud service authorizes the transaction, allowing it to proceed to completion (226). This could trigger an AWS Step Functions workflow that updates a DynamoDB table with {“transaction_id”: “xyz”, “status”: “authorized”}, notifying a payment gateway like Stripe via a POST request to process a $100 transfer. The authorization might also send a confirmation push notification to the initiating iPhone 15, displayed via Firebase Cloud Messaging, ensuring the user is informed.

If the transaction is not authorized due to a mismatch or timeout, an artificial intelligence in the cloud service generates a software update for a second device in the mesh (228). Running on a Google Cloud TPU, the AI could use a generative adversarial network trained on synthetic failure data to craft a firmware patch, compiled as a 50KB binary file tailored to a Fitbit Versa 4's ARM architecture. The update might be versioned in a Git repository hosted on the cloud, tracked with tags like “v1.2.3-security”.

The cloud service deploys this software update to the second device, transmitting it securely (230). An HTTPS POST request could deliver the binary to the Fitbit via its companion app on a paired Galaxy S23, using the Fitbit SDK to flash the update over Bluetooth Low Energy. The deployment might include a digital signature verified by the device's bootloader, ensuring authenticity before installation.

The second device restarts to implement the software update, activating new capabilities (232). The Fitbit could reboot in under 10 seconds, loading the patch into its RTOS kernel, which activates a proximity sensor previously dormant, controlled by an updated driver written in C. The restart might log a diagnostic event to the cloud via MQTT, confirming successful implementation with a timestamp.

The second device collects environmental data using the activated sensor, gathering contextual information (234). The proximity sensor might detect objects within 10 centimeters, sampled at 1 Hz, while an ambient light sensor records lux levels, both formatted as a CSV string—“10 cm, 50 lux” processed by a local Lua script. This data could be stored in a 1KB buffer, queued for transmission to avoid overwhelming the device's limited RAM.

The second device sends the environmental data to the cloud service through the steganographic network (236). The CSV string might be embedded in a 5-second MP3 clip of white noise using Steghide, uploaded to an S3 bucket via a REST API call over a 4G connection. The cloud service could reassemble the data from multiple carriers, verifying integrity with a CRC32 checksum before storage.

The artificial intelligence analyzes the environmental data to assess potential security risks (238). A PyTorch model on an AWS SageMaker endpoint might process the proximity and light data, comparing it against a baseline of “10 cm, 50 lux” from prior transactions, using a decision tree to flag deviations exceeding 20%. The analysis could run in a Jupyter notebook environment, outputting a risk score logged to CloudWatch for monitoring.

The AI determines if the environmental data indicates the presence of a third party near the second device (240). If proximity drops to 5 cm and light dims to 10 lux, suggesting someone else is close, the model might assign a 90% confidence score to third-party presence, updated in real-time via a WebSocket stream. This detection could trigger a secondary verification request, stored as a pending action in DynamoDB.

If a third party is detected, the cloud service blocks the transaction to prevent unauthorized access (242). An AWS Lambda function could update the transaction status to “blocked” in MongoDB, halting a $500 transfer by sending a cancellation signal to PayPal's API. The block might persist for 24 hours, configurable via a cloud admin panel, ensuring temporary protection.

The cloud service sends an alert to an authority if the transaction is blocked due to third-party detection (244). This could involve an SES email to a fraud monitoring team—“Subject: Transaction XYZ Blocked, Proximity Anomaly” or an SMS via Twilio to a predefined number, including the risk score and timestamp. The alert might also trigger a webhook to a third-party security service, integrating with their incident response system.

The cloud service logs the transaction attempt, recording a timestamp and the environmental data for future reference (246). A CloudWatch Logs entry might capture {“time”: “2025-03-21T10: 00:00Z”, “data”: “5 cm, 10 lux”, “status”: “blocked”}, stored with a 90-day retention policy. This log could be indexed in Elasticsearch, enabling queries for pattern analysis across multiple users.

Finally, the cloud service adjusts the time limit for providing steganographic image pieces based on historical transaction attempt patterns by the user (248). An AI-driven script might analyze logs in BigQuery, noting that the user averages 90 seconds for responses, adjusting the TTL from 120 to 100 seconds via a Cloud Function update to the Redis timer. This adjustment could be persisted in a user profile table, ensuring a tailored experience for subsequent transactions, completing the flow with adaptive precision.

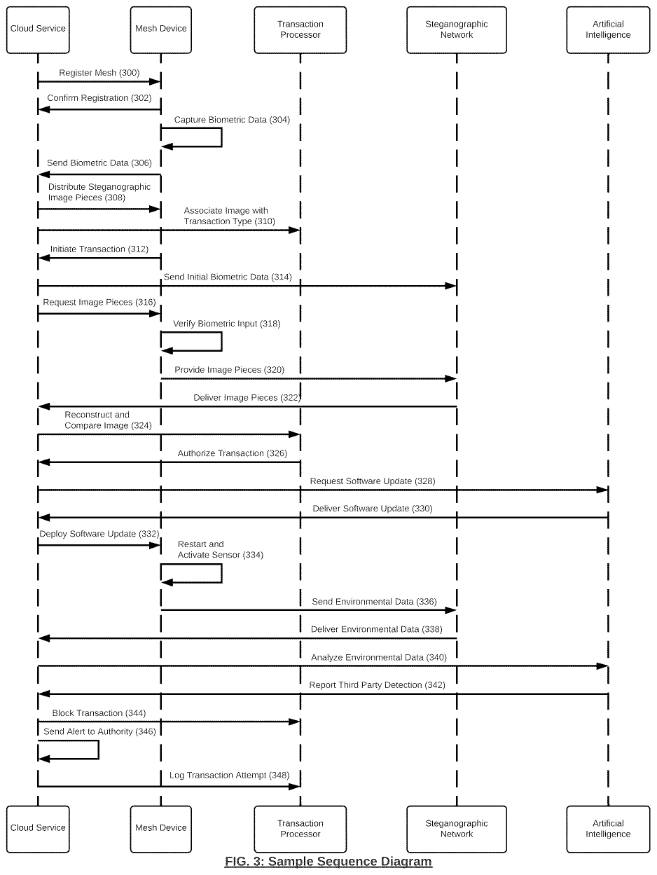

The FIG. 3 sequence diagram begins with the Cloud Service initiating the process by sending a registration request to the Mesh Device, establishing the foundation for a user's device network (300). This could be implemented using a RESTful API call from an AWS-based Cloud Service to a client app on devices like an iPhone 15 or Samsung Galaxy S23, where a POST request to an endpoint like “/api/register-mesh” carries a JSON payload with the user's ID and device details, authenticated via OAuth 2.0 tokens stored in AWS Cognito. The Mesh Device, representing a collective of user devices such as a laptop, smartphone, and smartwatch, processes this request by confirming its hardware identifiers and network status, then responds to the Cloud Service with a confirmation message (302). This response might be a 200 OK HTTP status with a JSON object—“{‘mesh_id’: ‘abc123’, ‘status’: ‘registered’}”—sent over a TLS 1.3 connection, logged in a CloudWatch stream for auditing.

Next, the Mesh Device interacts internally among its constituent devices to capture biometric data, coordinating the collection of hard and soft biometrics (304). For instance, an iPad Pro within the Mesh Device could use its TrueDepth camera to scan the user's eyes, while a Galaxy Watch records a swipe gesture via its touchscreen, with each device running a Swift or Kotlin app that syncs data via a local WebSocket server hosted on one device, like a Dell XPS laptop acting as a coordinator. The Mesh Device then sends this biometric data to the Cloud Service for further processing (306). This transmission might use a multipart/form-data POST request to “/api/biometrics”, embedding the data—e.g., base64-encoded eye scan and gesture coordinates—in a secure payload, routed through an API Gateway with rate limiting to prevent overload.

The Cloud Service, upon receiving the biometric data, generates a steganographic image and distributes its pieces back to the Mesh Device (308). A Python microservice on Google Cloud Run could process the data with the Stegano library, creating a 1024×1024 PNG image where biometric hashes adjust pixel values, then split it into segments using ImageMagick, sending each piece—“piece1.png”, “piece2.png” to devices like a Fitbit Versa 4 or Lenovo ThinkPad via a WebSocket push, encrypted with AES-256 and stored in device-specific secure directories. The Cloud Service also communicates with the Transaction Processor to associate the complete steganographic image with a transaction type, such as a payment (310). This might involve a GraphQL mutation—“associateImage(transactionType: ‘payment’, imageHash: ‘xyz789’)” executed on a Node.js server within AWS ECS, updating a MongoDB collection with the association, accessible via a Redis cache for speed.

The sequence progresses as the Mesh Device initiates a transaction by sending a request to the Cloud Service (312). An iPhone 15 could trigger this through a SwiftUI button press, prompting a thumb scan via LocalAuthentication, with the app crafting a JSON message—“{‘transaction_type’: ‘payment’, ‘device_id’: ‘iphone15’}”—sent to “/api/initiate” over HTTPS. The Cloud Service forwards the initial biometric data, like the thumb scan, to the Steganographic Network for secure transmission (314). This could use a custom protocol embedding the data in a JPEG of a sunset, leveraging OpenStego on an Nginx server, transmitted via a Kafka topic to ensure reliable delivery across cloud regions.

The Cloud Service then requests steganographic image pieces from a subset of devices within the Mesh Device (316). An AWS Lambda function might select two devices—e.g., a Galaxy S23 and an Echo Dot—randomly via a Python script, sending a “{‘request’: ‘image_piece’, ‘ttl’: 120}” payload over the Steganographic Network, with the TTL enforced by a Redis timer expiring after two minutes. The Mesh Device internally verifies current biometric input against stored data among its devices (318). The Galaxy S23 might prompt a thumb scan, compared using a TensorFlow Lite model with a 95% similarity threshold, while the Echo Dot checks a voice command, processed by a C-based firmware script, with results synced via a local MQTT broker.

Upon verification, the Mesh Device sends the image pieces to the Steganographic Network (320). The S23 could embed its piece in a WAV file using Steghide, sent over a 5G connection, while the Echo Dot uses a PNG carrier via Wi-Fi, both routed through a Cloudflare CDN edge node for low latency. The Steganographic Network delivers these pieces to the Cloud Service (322). An Apache Kafka consumer on the Cloud Service might reassemble the pieces from multiple topics—“piece1”, “piece2”—decrypting them with AWS KMS keys, storing them temporarily in an S3 bucket with a lifecycle policy of one hour.

The Cloud Service instructs the Transaction Processor to reconstruct and compare the steganographic image with the stored version (324). A Go microservice could stitch the pieces into a 1024×1024 image using the imaging library, then use scikit-image's SSIM to compare it against the stored hash in MongoDB, requiring a 98% match. The Transaction Processor authorizes the transaction if the images match, informing the Cloud Service (326). This might update a DynamoDB table—“{‘transaction_id’: ‘xyz’, ‘status’: ‘authorized’}”—and trigger a Stripe API call to process a $50 payment, with a confirmation sent via SNS to the user's email.

If authorization fails, the Cloud Service requests a software update from the Artificial Intelligence (328). A SageMaker endpoint could receive a “{‘device_id’: ‘fitbit4’, ‘reason’: ‘auth_failed’}” request, prompting a PyTorch GAN to generate a 100KB firmware patch for a Fitbit Versa 4, versioned in a Bitbucket repo. The Artificial Intelligence delivers this update to the Cloud Service (330). The patch might be signed with a private key, sent as a binary file over a REST API response, stored in an S3 bucket with server-side encryption.

The Cloud Service deploys the software update to the Mesh Device, targeting a specific device like the Fitbit (332). An HTTPS POST to “/api/update” could deliver the binary via the Fitbit app on a paired iPhone, flashed over Bluetooth with a CRC32 checksum verification. The Mesh Device restarts the targeted device and activates its sensor internally (334). The Fitbit could reboot in 15 seconds, loading the patch into its RTOS, enabling a proximity sensor via an updated I2C driver, with a success log sent via MQTT to the Cloud Service.

The Mesh Device collects and sends environmental data to the Steganographic Network (336). The Fitbit might sample proximity at 5 cm and light at 20 lux, encoded in a JSON—“{‘prox’: 5, ‘lux’: 20}”—embedded in an MP 3 file, uploaded over LTE. The Steganographic Network delivers this data to the Cloud Service (338). A Kafka consumer could extract the JSON from the carrier, storing it in a BigQuery table for analysis, with a retry mechanism for failed deliveries.

The Cloud Service requests the Artificial Intelligence to analyze the environmental data (340). A TensorFlow model on an EC2 instance might process the data against a baseline, using a random forest to assign a 90% risk score for “5 cm, 20 lux”, logged in CloudWatch. The Artificial Intelligence reports any third-party detection to the Cloud Service (342). A “{‘risk’: ‘third_party’, ‘confidence’: 0.9}” response could be sent via a WebSocket, triggering a secondary action stored in Redis.

If a third party is detected, the Cloud Service instructs the Transaction Processor to block the transaction (344). An AWS Step Functions state machine could update the transaction to “blocked” in DynamoDB, canceling a $200 transfer via PayPal's API, with a 48-hour lockout period. The Cloud Service sends an alert to an authority (346). An SES email—“Subject: Suspicious Activity, Transaction XYZ”—might include the risk score, sent to a fraud team, while a Twilio SMS delivers a summary to an admin number.

Finally, the Cloud Service logs the transaction attempt with the Transaction Processor (348). A CloudWatch Logs entry—“{‘time’: ‘2025-03-21T10:00:00Z’, ‘data’: ‘5 cm, 20 lux’, ‘status’: ‘blocked’}”—could be indexed in Elasticsearch, with a 90-day retention, enabling future pattern analysis via a Kibana dashboard, completing the sequence with comprehensive tracking and adaptability.

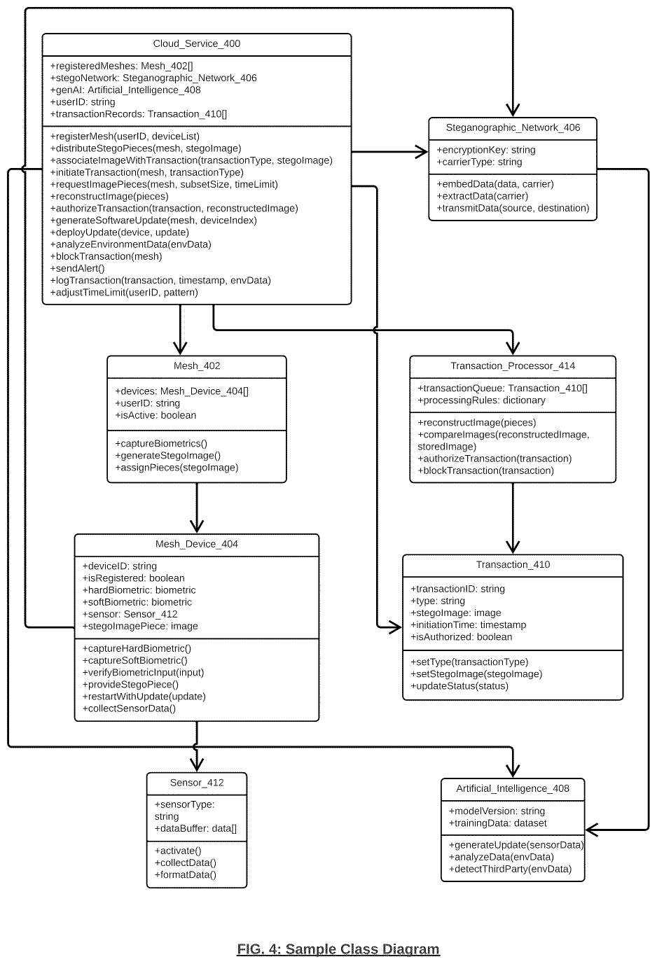

The FIG. 4 class diagram commences with the Cloud Service (400) class, which serves as the central orchestrator of the invention's functionality, managing a vast array of operations and data across the system. This class contains attributes such as registeredMeshes, an array storing instances of the Mesh (402) class to track all user device networks, stegoNetwork, an instance of the Steganographic Network (406) class for secure communication, and genAI, an instance of the Artificial Intelligence (408) class for adaptive processing. Additional attributes include userID, a string uniquely identifying the user, and transactionRecords, an array of Transaction (410) instances logging all transaction attempts. The methods of Cloud Service (400) are extensive, reflecting its role in coordinating the system. For instance, registerMesh(userID, deviceList) could be implemented in Java using Spring Boot, creating a new Mesh (402) instance by querying a PostgreSQL database hosted on AWS RDS to verify the userID and adding device metadata from the deviceList parameter, stored as JSON objects. The distributeStegoPieces(mesh, stegoImage) method might leverage a Python script with the Pillow library to segment a steganographic image into pieces, distributing them via an HTTPS POST request to each device in the mesh, encrypted with AES-256 using a key managed by AWS KMS. Other methods like initiateTransaction(mesh, transactionType) could trigger a RESTful API call to start a transaction, while analyzeEnvironmentData(envData) might invoke a TensorFlow model on a SageMaker endpoint to process sensor data, showcasing the class's multifaceted responsibilities.

The Mesh (402) class represents a collection of devices associated with a user, encapsulating their collective behavior within the system. Its attributes include devices, an array of Mesh Device (404) instances detailing each device in the network, userID, a string tying the mesh to a specific user, and isActive, a boolean indicating operational status. The captureBiometrics( ) method could be realized in C on a .NET Core app running across devices, coordinating biometric data collection by invoking device-specific APIs—such as Android's BiometricPrompt or iOS's LocalAuthentication—via a SignalR hub for real-time synchronization. The generateStegoImage( ) method might use a Node.js module with the Jimp library to craft a steganographic image from biometric hashes, storing the result temporarily in a Redis cache before division. The assignPieces(stegoImage) method could distribute image segments to devices using a WebSocket connection, ensuring each piece is securely placed in a device's filesystem, like/secure/stego on a Linux-based smartwatch, protected by file permissions.

The Mesh Device (404) class defines the properties and behaviors of individual devices within the Mesh (402), forming the backbone of distributed authentication. Attributes include deviceID, a string like “iphone15” for unique identification, isRegistered, a boolean confirming mesh membership, and hardBiometric and softBiometric, data structures holding biometric inputs such as thumb scans or swipe gestures. The sensor attribute links to a Sensor (412) instance, while stegoImagePiece stores a segment of the steganographic image. Methods like captureHardBiometric( ) could be implemented in Swift on an iPhone, using the TrueDepth camera to scan eyes, returning a base64-encoded string stored in the Secure Enclave. The verifyBiometricInput(input) method might employ a Python script with scikit-learn to compare real-time biometric data against stored values using cosine similarity, executed on a Raspberry Pi-based IoT device. The restartWithUpdate(update) method could flash a firmware binary to a Fitbit Versa 4 using an OTA update process over Bluetooth, managed by a C-based bootloader, highlighting the class's role in device-level security.

The Steganographic Network (406) class manages secure data transmission across the system, with attributes encryptionKey, a string for AES-256 encryption, and carrierType, a string specifying the data carrier (e.g., “PNG” or “WAV”). The embedData(data, carrier) method could use a Go program with the Stego library to hide biometric data in a JPEG, adjusting pixel least significant bits, while extractData(carrier) reverses this on an Nginx server, retrieving the data for processing. The transmitData(source, destination) method might leverage Kafka topics to route carriers between actors like Cloud Service (400) and Mesh Device (404), ensuring reliability with a retry mechanism over a TLS connection, integral to maintaining confidentiality throughout the system.

The Artificial Intelligence (408) class provides adaptive intelligence, with attributes modelVersion, a string like “v2.1” tracking updates, and trainingData, a dataset of anonymized sensor and transaction logs. The generateUpdate(sensorData) method could deploy a PyTorch GAN on Google Cloud TPU, producing a 200KB firmware patch for a device based on proximity data, stored in a GCS bucket. The analyzeData(envData) method might process light and proximity readings with a random forest model, running in a Docker container on Kubernetes, while detectThirdParty(envData) uses a logistic regression classifier to flag anomalies, outputting a confidence score via a REST API, enhancing the system's responsiveness.

The Transaction (410) class encapsulates transaction details, with attributes transactionID, a unique string like “txn789”, type, a string like “payment”, stegoImage, the associated image, initiationTime, a timestamp, and isAuthorized, a boolean. The setType(transactionType) method could update the type in a MongoDB document via a Java Spring Data repository, while setStegoImage(stegoImage) assigns the image hash, and updateStatus(status) modifies the authorization state, logged to CloudWatch, supporting transaction management across the system.

The Sensor (412) class represents device sensors, with attributes sensorType, a string like “proximity”, and dataBuffer, an array storing readings. The activate( ) method could initialize a sensor on a Galaxy S23 via Android's SensorManager, while collectData( ) gathers 1 Hz samples of light levels, formatted by formatData( ) into JSON—“{‘lux’: 50}”—processed by a Kotlin coroutine, enabling environmental awareness critical to security checks.

The Transaction Processor (414) class handles transaction validation, with attributes transactionQueue, an array of pending Transaction (410) instances, and processingRules, a dictionary of criteria. The reconstructImage(pieces) method might stitch segments in C++ using OpenCV, running on an EC2 instance, while compareImages(reconstructedImage, storedImage) uses SSIM in Python, and authorizeTransaction(transaction) updates status via a REST call, with blockTransaction(transaction) halting progress, ensuring robust transaction handling.

The connections illustrate the system's structure. The association from Cloud Service (400) to Mesh (402) reflects the management of device networks, implemented via a one-to-many relationship in a relational database. The Cloud Service (400) to Steganographic Network (406) association enables secure communication, possibly via dependency injection in a Spring application. The link to Artificial Intelligence (408) supports adaptive features, coded as a service call in a microservices architecture, while the association to Transaction Processor (414) facilitates transaction workflows, managed through message queues like RabbitMQ. The Mesh (402) to Mesh Device (404) association aggregates devices, implemented with an array in Java, and Mesh Device (404) to Steganographic Network (406) and Sensor (412) associations handle data flow and sensing, coded with event-driven callbacks. The Steganographic Network (406) to Artificial Intelligence (408) and Transaction Processor (414) to Transaction (410) associations ensure data processing, while Cloud Service (400) to Transaction (410) ties transactions to the system, all forming a cohesive, object-oriented framework for secure multi-device transactions.

Pseudocode exemplars for implementing various aspects of this disclosure are set forth below with explanations for reference.

```
// Define global structures and variables
STRUCT Device {
  STRING deviceID
  BOOLEAN isRegistered
  BIOMETRIC hardBiometric
  BIOMETRIC softBiometric
  SENSOR sensorArray
  IMAGE stegoImagePiece
}
STRUCT Mesh {
  ARRAY<Device> devices
  STRING userID
  BOOLEAN isActive
}
STRUCT Transaction {
  STRING transactionID
  STRING type
  IMAGE stegoImage
  TIMESTAMP initiationTime
  BOOLEAN isAuthorized
}
STRUCT Cloud {
  ARRAY<Mesh> registeredMeshes
  NETWORK stegoNetwork
  AI genAI
}
// Function to register a user's mesh
FUNCTION registerMesh(userID, deviceList):
  SET newMesh = CREATE Mesh
  SET newMesh.userID = userID
  SET newMesh.isActive = TRUE
  FOR EACH device IN deviceList:
    SET newDevice = CREATE Device
    SET newDevice.deviceID = device.deviceID
    SET newDevice.isRegistered = TRUE
    ADD newDevice TO newMesh.devices
  ADD newMesh TO Cloud.registeredMeshes
  RETURN newMesh
// Function to capture and store biometrics on devices
FUNCTION captureBiometrics(mesh):
  FOR EACH device IN mesh.devices:
    SET device.hardBiometric = CAPTURE_HARDBIOMETRIC(device)
    SET device.softBiometric = CAPTURE_SOFTBIOMETRIC(device)
  RETURN mesh
// Function to generate steganographic images
FUNCTION generateStegoImages(mesh):
  SET fullImage = CREATE_EMPTY_IMAGE
  FOR EACH device IN mesh.devices:
    SET piece = CREATE_IMAGE_PIECE(device.hardBiometric, device.softBiometric)
    SET device.stegoImagePiece = piece
    COMBINE piece INTO fullImage
  RETURN fullImage
// Function to tie stego image to transaction type
FUNCTION tieStegoToTransaction(transactionType, stegoImage):
  SET newTransaction = CREATE Transaction
  SET newTransaction.type = transactionType
  SET newTransaction.stegoImage = stegoImage
  RETURN newTransaction
// Function to initiate transaction
FUNCTION initiateTransaction(mesh, transactionType):
  SET transaction = FIND_TRANSACTION_BY_TYPE(transactionType, Cloud)
  SET transaction.initiationTime = CURRENT_TIMESTAMP
  SET biometricData = COLLECT_BIOMETRICS_FROM_DEVICE(mesh.devices[0])
  SEND biometricData TO Cloud.stegoNetwork
  RETURN transaction
// Function to validate user with mesh and stego images
FUNCTION validateUser(transaction, mesh, partialMeshSize):
  SET requiredDevices = SELECT_RANDOM_DEVICES(mesh.devices, partialMeshSize)
  SET timeToLiveToken = GENERATE_TOKEN(120) // 2 minutes
  SET collectedPieces = CREATE_EMPTY_ARRAY
  FOR EACH device IN requiredDevices:
    SET biometricInput = REQUEST_BIOMETRIC(device)
    IF biometricInput MATCHES device.hardBiometric OR device.softBiometric:
      ADD device.stegoImagePiece TO collectedPieces
  IF LENGTH(collectedPieces) EQUALS LENGTH(requiredDevices):
    SET reconstructedImage = RECONSTRUCT_IMAGE(collectedPieces)
    IF reconstructedImage MATCHES transaction.stegoImage:
      SET transaction.isAuthorized = TRUE
  RETURN transaction.isAuthorized
// Function to generate AI-based software update
FUNCTION generateSoftwareUpdate(mesh, deviceIndex):
  SET targetDevice = mesh.devices[deviceIndex]
  SET sensorData = COLLECT_SENSOR_DATA(targetDevice.sensorArray)
  SET update = Cloud.genAI.GENERATE_UPDATE(sensorData)
  RETURN update
// Function to deploy software update and collect environment data
FUNCTION deployUpdateAndSense(device, update):
  RESTART device WITH update
  SET envData = ACTIVATE_SENSOR(device.sensorArray)
  RETURN envData
// Function to analyze environment data with AI
FUNCTION analyzeEnvironment(mesh, envData):
  SET analysisResult = Cloud.genAI.ANALYZE(envData)
  IF analysisResult.INDICATES_THIRD_PARTY:
    SEND_ALERT_TO_AUTHORITIES( )
    BLOCK_TRANSACTION(mesh)
  RETURN analysisResult
// Main execution flow
SET userMesh = registerMesh(“user123”, deviceList)
SET userMesh = captureBiometrics(userMesh)
SET stegoImage = generateStegoImages(userMesh)
SET transaction = tieStegoToTransaction(“payment”, stegoImage)
SET transaction = initiateTransaction(userMesh, “payment”)
SET isValid = validateUser(transaction, userMesh, 3)
IF NOT isValid:
  SET update = generateSoftwareUpdate(userMesh, 0)
  SET envData = deployUpdateAndSense(userMesh.devices[0], update)
  SET result = analyzeEnvironment(userMesh, envData)
IF isValid:
  PROCESS_TRANSACTION(transaction)
```

The pseudocode begins by defining core structures to represent the system's components. A Device structure holds details like a unique identifier, registration status, biometric data, sensor information, and a piece of a steganographic image. A Mesh structure groups multiple devices under a user's identifier, tracking whether it remains active. A Transaction structure captures details such as an identifier, type, associated steganographic image, initiation time, and authorization status. A Cloud structure manages all registered meshes, a steganographic network for secure communication, and an AI component for generating updates and analysis.

A function to register a mesh takes a user identifier and a list of devices, creating a new mesh instance. It assigns the user identifier, marks the mesh as active, and iterates through the device list to register each one, adding them to the mesh's device array. This mesh then joins a collection of meshes stored in the cloud, establishing the user's device ecosystem for subsequent operations.

Another function captures biometric data across the mesh's devices. It loops through each device, collecting hard biometrics like thumb and eye scans, and soft biometrics like gestures, storing them within each device's structure. This step ensures every device in the mesh has up-to-date biometric information tied to the user, forming the basis for authentication.

Generating steganographic images involves creating a composite image from biometric data. The function initializes an empty image, then iterates over the mesh's devices, producing an image piece for each using its hard and soft biometrics. These pieces are stored in the respective devices and combined into a full image, which the function returns for later use in transactions.

Tying a steganographic image to a transaction type occurs through a dedicated function. It creates a new transaction instance, assigns the specified type and the provided steganographic image, and returns this transaction object. This linkage allows the system to associate specific images with different transaction categories, enabling targeted authentication.

Initiating a transaction starts with finding a transaction by its type from the cloud's records. The function sets the current timestamp, collects biometric data from the first device in the mesh, and sends this data to the cloud via the steganographic network. It returns the transaction object, marking the beginning of the validation process.

Validating a user involves selecting a random subset of devices from the mesh based on a specified size for partial mesh participation. A time-to-live token with a two-minute duration is generated, and an array collects image pieces from the selected devices. Each device requests biometric input from the user, comparing it to stored biometrics; if it matches, the device's image piece is added to the collection. The function reconstructs the image from these pieces and checks it against the transaction's steganographic image, authorizing the transaction if they align.

If validation fails, a function generates a software update using AI. It targets a specific device in the mesh, collects initial sensor data, and passes this to the cloud's generative AI component, which crafts a custom update. This update aims to enhance the device's ability to assess its surroundings, addressing potential security concerns.

Deploying the software update restarts the targeted device with the new code. The function activates the device's sensor array to gather environmental data, such as light levels or proximity information, and returns this data. This step leverages the updated sensor capabilities to provide a detailed context for further analysis.

Analyzing the environmental data uses the cloud's AI to process the collected information. The function evaluates whether the data suggests a third-party presence or other anomalies, triggering alerts to authorities and blocking transactions if necessary. It returns the analysis result, informing the system's next steps.

The main execution flow ties these functions together into a cohesive process. It registers a mesh for a user with a provided device list, captures biometrics across the mesh, and generates a steganographic image from them. A transaction for a payment type is created and linked to this image, then initiated using the mesh. Validation attempts to authorize the transaction with a partial mesh of three devices; if this fails, the system generates and deploys a software update to the first device, collects environmental data, and analyzes it. If validation succeeds, the transaction processes.

This pseudocode incorporates the invention's use of a device mesh for distributed authentication. It reflects the registration of multiple devices under a user's profile, stored in a cloud repository, ensuring a unified network for transaction security.

The biometric capture and steganographic image generation highlight the invention's dual use of hard and soft biometrics. These are combined into images where each device holds a unique piece, enabling a distributed yet cohesive authentication mechanism.

The transaction initiation and validation functions showcase the steganographic network's role in secure communication. Biometric data and image pieces transmit through this network, maintaining confidentiality between the cloud and mesh devices.

The partial or full mesh validation option appears in the user validation function. It randomly selects devices to contribute image pieces, reconstructing them under a time constraint, mirroring the invention's flexible yet secure approach.

The AI-generated software update function embodies the invention's adaptive response to failed validations. It targets specific devices, enhancing their sensors to gather contextual data, reflecting the use of generative AI for real-time adjustments.

Deploying the update and sensing the environment leverages pre-identified sensors within devices. This step collects physical data to inform security decisions, a unique aspect of the invention's design.

The environmental analysis function uses cloud-based AI to process sensor data. It detects anomalies and takes action like alerting authorities or blocking transactions, showcasing the invention's proactive security measures.

The main flow ensures all components work sequentially. It starts with mesh registration, progresses through biometric and image creation, initiates a transaction, validates it, and, if needed, adapts with AI updates and analysis, covering the invention's full scope.

This implementation captures the invention's unique features, such as steganographic images tied to transactions, random mesh participation, and AI-driven environmental sensing. It provides a detailed blueprint for a system securing multi-device transactions.

The systems and methods described in the disclosure allow for numerous alternatives, modifications, combinations, and customizations that remain consistent with its underlying principles. One alternative involves varying the types of biometric data used across the mesh devices. Instead of relying on a fixed combination of hard biometrics like thumb and eye scans or soft biometrics like gestures, the system could incorporate voice recognition or facial scans where devices support such capabilities. This adjustment accommodates devices with different sensor arrays while maintaining the requirement for user-specific authentication data to generate steganographic images.

Another modification could alter the structure of the steganographic images themselves. The current approach divides a single image into pieces assigned to each device, but an alternative might involve creating multiple distinct steganographic images, each tied to a subset of devices within the mesh. For example, one image could link to mobile devices, while another connects to IoT gadgets, allowing the system to select an image based on the transaction's context or device availability, enhancing flexibility without departing from the core concept of distributed authentication.

The number of devices required for validation presents a customizable aspect. The described method permits either full or partial mesh participation, such as requesting pieces from three out of five devices. This could be modified to set a minimum threshold based on transaction value—requiring all devices for high-value exchanges and fewer for routine ones—or to dynamically adjust the threshold according to historical user patterns, ensuring security aligns with situational needs while adhering to the mesh-based validation framework.

A combination of network types offers another variation. While the disclosure specifies a steganographic network for secure communication between the cloud and mesh, this could be paired with a secondary protocol, such as a blockchain ledger, to log transaction attempts and validation outcomes. This hybrid approach would add redundancy and traceability, reinforcing the system's integrity without altering its reliance on steganographic concealment for primary data transmission.

Customization of the time-to-live token provides additional flexibility. The two-minute window outlined could be adjusted to shorter or longer durations depending on the transaction type or user preference, such as 30 seconds for quick verifications or five minutes for complex multi-step processes. This tweak maintains the time-bound authentication principle while adapting to diverse operational contexts.

The source of biometric data collection could also shift. Instead of capturing biometrics directly from each device at registration, the system might pull existing biometric profiles from a trusted third-party database, assuming user consent, and distribute them across the mesh. This modification streamlines setup while preserving the use of biometrics to create steganographic images and validate transactions.

An alternative to the AI-generated software update involves the type of sensor data collected. Beyond light levels or proximity, the system could prioritize geolocation coordinates or audio signatures from the device's microphone, depending on what sensors the device supports. This customization ensures the environmental analysis remains robust across varied hardware, staying true to the goal of contextual security assessment.

A combination of update triggers could enhance the system's responsiveness. Rather than generating a software update only after repeated validation failures, the cloud could initiate updates proactively if initial biometric mismatches suggest potential issues, or if sensor data from a prior transaction indicates an anomaly. This blend of reactive and predictive updates aligns with the disclosure's adaptive security focus.

The method of image reconstruction offers room for modification. Instead of requiring an exact match between the reconstructed steganographic image and the stored version, the system could accept a partial match within a tolerance threshold—say, 90% similarity—accounting for minor biometric variations over time. This adjustment retains the image-based validation core while accommodating natural user changes.

Another customization could involve the AI's role in transaction authorization. Beyond analyzing environmental data, the AI might evaluate historical transaction patterns across the mesh to assign a trust score, influencing whether full or partial mesh validation is required. This integration of past and present data strengthens the system's decision-making without deviating from its reliance on mesh and AI components.

The mesh composition itself could vary. While the disclosure envisions a mix of mobile and IoT devices, an alternative might restrict the mesh to a single device category, such as only smartphones, for users with limited hardware diversity. Conversely, it could expand to include cloud-linked wearables or vehicle systems, broadening the ecosystem while keeping the distributed authentication intact.

A modification to the alert mechanism could refine its scope. Instead of sending alerts to authorities for every detected anomaly, the system might first notify the user via a secure channel, escalating only if the user fails to respond within a set period. This tiered approach maintains the protective intent while reducing unnecessary external involvement.

Combining biometric types across devices offers another possibility. The system could require a hard biometric from one device and a soft biometric from another within the same validation cycle, rather than allowing either type per device. This hybrid requirement increases security complexity while staying within the biometric and mesh framework.

The storage location of steganographic images could shift as an alternative. Rather than keeping them solely in the cloud, the system might distribute encrypted copies across the mesh devices themselves, with the cloud holding only a primary or controlling key. This decentralized storage enhances resilience against cloud breaches while preserving the steganographic validation process.

Customization of the sensor update process could involve frequency. Instead of a one-time update per failed validation, the system might schedule periodic updates to all mesh devices, refreshing their sensor capabilities based on AI analysis of long-term trends. This proactive maintenance aligns with the disclosure's adaptive security enhancements.

An alternative communication method could supplement the steganographic network. For instance, adding a quantum key distribution layer could bolster encryption for devices supporting it, while the steganographic network remains the primary channel. This combination strengthens data security without abandoning the core concealment technique.

The AI analysis could extend to predictive modeling. Beyond reacting to current environmental data, it might forecast potential risks based on device usage patterns, prompting preemptive measures like tightened validation requirements. This forward-looking approach fits the disclosure's emphasis on AI-driven adaptability.

A modification to transaction blocking could introduce granularity. Instead of halting all large or frequent transactions upon anomaly detection, the system might suspend only those exceeding a specific threshold, allowing smaller ones to proceed pending further review. This nuanced response keeps the protective mechanism intact while minimizing disruption.

Combining mesh validation with external authentication offers another variation. The system could integrate a one-time password from a non-mesh device as an additional step, used alongside steganographic image validation, enhancing security layers while retaining the mesh-centric design.

While the present technology has been explained through what are currently regarded as the most practical and preferred embodiments, it should be recognized that these specifics are provided solely for illustrative purposes, and the disclosure is not confined to the particular descriptions and embodiments outlined. Instead, it is intended to encompass modifications and comparable arrangements that fall within the spirit and scope of the appended claims. For instance, it is understood that the present technology envisions the possibility of integrating, where feasible, one or more elements from any given embodiment with one or more elements from any other embodiment. These alternatives, modifications, combinations, and customizations demonstrate the disclosure's adaptability, ensuring its principles apply across diverse implementations.

1. A method for securing transactions across multiple devices, comprising:
registering, by a cloud service, a mesh of devices associated with a user, wherein the mesh includes a plurality of devices each configured to communicate with the cloud service;
capturing, by each device in the mesh, biometric data including a hard biometric and a soft biometric specific to the user;
generating, by the mesh, a steganographic image using the biometric data, wherein the steganographic image is divided into pieces, each piece assigned to a respective device in the mesh;
associating, by the cloud service, the steganographic image with a transaction type;
initiating, by a first device in the mesh, a transaction of the transaction type by sending initial biometric data to the cloud service via a steganographic network;
validating, by the cloud service, the transaction by requesting a subset of the devices in the mesh to provide their respective pieces of the steganographic image within a time limit, wherein each device in the subset provides its piece upon verifying current biometric data against the captured biometric data;
reconstructing, by the cloud service, the steganographic image from the provided pieces; and
authorizing, by the cloud service, the transaction if the reconstructed steganographic image matches the associated steganographic image.

2. The method of claim 1, wherein the subset of the devices includes at least two devices but fewer than all devices in the mesh.

3. The method of claim 2, further comprising:
selecting, by the cloud service, the subset of the devices randomly from the mesh; and
adjusting, by the cloud service, a size of the subset based on a value of the transaction.

4. The method of claim 3, wherein the hard biometric includes a combination of a thumb scan and an eye scan captured by each device in the mesh.

5. The method of claim 4, further comprising:
generating, by an artificial intelligence in the cloud service, a software update for a second device in the mesh if the transaction is not authorized;
deploying, by the cloud service, the software update to the second device; and
restarting, by the second device, to implement the software update.

6. The method of claim 5, wherein the software update activates a sensor in the second device to collect environmental data including light levels and proximity information.

7. The method of claim 6, further comprising:
sending, by the second device, the environmental data to the cloud service via the steganographic network; and
analyzing, by the artificial intelligence, the environmental data to detect a presence of a third party near the second device.

8. The method of claim 7, wherein the cloud service blocks the transaction if the artificial intelligence detects the presence of the third party.

9. The method of claim 8, further comprising:
sending, by the cloud service, an alert to an authority if the transaction is blocked; and
logging, by the cloud service, the transaction attempt with a timestamp and the environmental data.

10. The method of claim 9, wherein the cloud service adjusts the time limit for providing the pieces of the steganographic image based on a historical pattern of transaction attempts by the user.

11. A method for securing transactions across multiple devices, comprising:
registering, by a cloud service, a mesh of devices associated with a user, wherein the mesh includes a plurality of devices each configured to communicate with the cloud service;
capturing, by each device in the mesh, biometric data including a hard biometric and a soft biometric specific to the user;
generating, by the mesh, a steganographic image using the biometric data, wherein the steganographic image is divided into pieces, each piece assigned to a respective device in the mesh;
associating, by the cloud service, the steganographic image with a transaction type;
initiating, by a first device in the mesh, a transaction of the transaction type by sending initial biometric data to the cloud service via a steganographic network;
validating, by the cloud service, the transaction by requesting a subset of the devices in the mesh to provide their respective pieces of the steganographic image within a time limit, wherein each device in the subset provides its piece upon verifying current biometric data against the captured biometric data, and wherein the subset includes at least two devices but fewer than all devices in the mesh;
selecting, by the cloud service, the subset of the devices randomly from the mesh;
adjusting, by the cloud service, a size of the subset based on a value of the transaction;
reconstructing, by the cloud service, the steganographic image from the provided pieces;
authorizing, by the cloud service, the transaction if the reconstructed steganographic image matches the associated steganographic image;
generating, by an artificial intelligence in the cloud service, a software update for a second device in the mesh if the transaction is not authorized;
deploying, by the cloud service, the software update to the second device;
restarting, by the second device, to implement the software update, wherein the software update activates a sensor in the second device to collect environmental data including light levels and proximity information;
sending, by the second device, the environmental data to the cloud service via the steganographic network;
analyzing, by the artificial intelligence, the environmental data to detect a presence of a third party near the second device;
blocking, by the cloud service, the transaction if the artificial intelligence detects the presence of the third party;
sending, by the cloud service, an alert to an authority if the transaction is blocked;
logging, by the cloud service, the transaction attempt with a timestamp and the environmental data;
adjusting, by the cloud service, the time limit for providing the pieces of the steganographic image based on a historical pattern of transaction attempts by the user;
encrypting, by the cloud service, the steganographic image prior to storage; and
distributing, by the cloud service, a decryption key to the mesh for reconstructing the steganographic image during validation.

12. A system for securing transactions across multiple devices, comprising:
a cloud service configured to register a mesh of devices associated with a user, wherein the mesh includes a plurality of devices each configured to communicate with the cloud service;
the plurality of devices in the mesh, each configured to capture biometric data including a hard biometric and a soft biometric specific to the user;
the mesh configured to generate a steganographic image using the biometric data, wherein the steganographic image is divided into pieces, each piece assigned to a respective device in the mesh;
the cloud service further configured to associate the steganographic image with a transaction type;
a first device in the mesh configured to initiate a transaction of the transaction type by sending initial biometric data to the cloud service via a steganographic network;
the cloud service further configured to validate the transaction by requesting a subset of the devices in the mesh to provide their respective pieces of the steganographic image within a time limit, wherein each device in the subset is configured to provide its piece upon verifying current biometric data against the captured biometric data;
the cloud service further configured to reconstruct the steganographic image from the provided pieces; and
the cloud service further configured to authorize the transaction if the reconstructed steganographic image matches the associated steganographic image.

13. The system of claim 12, wherein the cloud service is further configured to select the subset of the devices randomly from the mesh.

14. The system of claim 13, wherein the plurality of devices includes at least one mobile device and at least one Internet of Things device.

15. The system of claim 14, further comprising:
an artificial intelligence in the cloud service configured to generate a software update for a second device in the mesh if the transaction is not authorized; and
the second device configured to restart upon receiving the software update from the cloud service.

16. The system of claim 15, wherein the second device is further configured to collect environmental data using a sensor activated by the software update.

17. The system of claim 16, wherein the cloud service is further configured to analyze the environmental data to assess a security condition of the second device.

18. The system of claim 17, further comprising:
the cloud service further configured to block the transaction based on the security condition; and
the cloud service further configured to send a notification to the user if the transaction is blocked.

19. The system of claim 18, wherein the cloud service is further configured to adjust a size of the subset based on a predefined criterion associated with the transaction.

20. The system of claim 19, further comprising:
the cloud service further configured to encrypt all communications within the steganographic network using a unique key generated for each transaction;
the artificial intelligence further configured to predict a potential security threat based on a pattern of environmental data collected from the second device over multiple transactions;
the cloud service further configured to request additional biometric data from a third device in the mesh if the potential security threat is predicted;
the third device configured to provide the additional biometric data to update its respective piece of the steganographic image; and
the cloud service further configured to revalidate the transaction using the updated piece from the third device in combination with the pieces from the subset, wherein the revalidation occurs within an extended time limit determined by the artificial intelligence based on the predicted security threat.
